(19) United States
(12) Patent Application Publication
(10) Pub. No.: US 2013/0080224 A1
(43) Pub. Date: Mar. 28, 2013

(54) METHOD AND APPARATUS FOR AN ONLINE STORY SHARING SERVICE

(71) Applicants: Scott Thomas O'Brien, Palo Alto, CA (US); William Hendrickson Taylor, IV, Palo Alto, CA (US); Ethan Douglas Straffin, Palo Alto, CA (US)

(72) Inventors: Scott Thomas O'Brien, Palo Alto, CA (US); William Hendrickson Taylor, IV, Palo Alto, CA (US); Ethan Douglas Straffin, Palo Alto, CA (US)

(21) Appl. No.: 13/623,823

(22) Filed: Sep. 20, 2012

Related U.S. Application Data
(60) Provisional application No. 61/538,750, filed on Sep. 23, 2011.

(51) Int. Cl. G06Q 30/02

(52) U.S. Cl. 705/14.14

(57) ABSTRACT

An online story sharing service is described. The online story sharing service includes a server that includes a submit story application component that is configured to allow users of the story sharing service to submit stories, each story including one or more of a written component, an audio component, an image component, and a video component. The server further includes a view story application component that is configured to allow users to view stories that have been submitted. The server further includes an external destination share application component that is configured to allow users of the online story sharing service to share links of stories with one or more external destinations. The server further includes a story contest module to conduct story contest. Each story contest is for a predetermined duration of time and includes multiple entries. For the story contest, the story contest module tracks a set of attributes for each story entered into the contest that indicate an interest level of that story relative to the interest level of the other stories; determines winning story(ies) based on the tracked attributes; and provides a reward to the users that submitted the winning story(ies).

### CROSS-REFERENCE TO RELATED APPLICATIONS

This application claims the benefit of U.S. Provisional Application No. 61/538,750, filed Sep. 23, 2011, which is hereby incorporated by reference.

### FIELD

Embodiments of the invention relate to the field of online communities; and more specifically, to a method and apparatus for an online story sharing service.

### BACKGROUND

Social networking services are online communities that provide for communication and information sharing between users. By way of example, social networking services allow users to share their pictures, videos, and other information with their online friends or other users. Users may manage online friends through the social networking service through an invitation process. Social networking services commonly allow users to communicate by posting short messages to a notifications area of an online friend, sending emails or other private messages, and/or through real-time communication such as instant messaging or video chatting.

Video sharing and other multimedia services provide for online sharing of video or other multimedia. For example, video sharing websites allow registered users to submit videos to the site that are then generally accessible and viewable by the public. Image sharing websites allow registered users to submit images to the site that can be shared with the general public.

### SUMMARY

An online story sharing service is described. In one embodiment, the online story sharing service that includes a submit story application component that is configured to allow users of the story sharing service to submit stories, each story including one or more of a written component, an audio component, an image component, and a video component. The service further includes a view story application component that is configured to allow users to view stories that have been submitted. The service further includes an external destination share application component that is configured to allow users of the online story sharing service to share links of stories with one or more external destinations. The service further includes a story contest module to conduct story contest. Each story contest is for a predetermined duration of time and includes multiple entries. For the story contest, the story contest module tracks a set of attributes for each story entered into the contest that indicate an interest level of that story relative to the interest level of the other stories; determines winning story(ies) based on the tracked attributes; and provides a reward to the users that submitted the winning story(ies). Other embodiments are described herein.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary online story sharing service according to one embodiment;

FIG. 2 is a flow diagram that illustrates exemplary operations for conducting an online story contest according to one embodiment;

FIG. 3 illustrates a logical representation of an exemplary application for the online story sharing service described herein according to one embodiment;

FIG. 4 illustrates an exemplary home application component of the online story sharing service according to one embodiment;

FIG. 5 illustrates an exemplary story search application component of the online story sharing service according to one embodiment;

FIG. 6 illustrates an exemplary view story application component of the online story sharing service according to one embodiment;

FIG. 7 illustrates a comment application component of the online story sharing service according to one embodiment;

FIG. 8 illustrates an exemplary personalized dashboard application component of the online story sharing service according to one embodiment;

FIG. 9 illustrates an exemplary application component of the online story sharing service that allows a user to view and/or edit their account information according to one embodiment;

FIG. 10 illustrates an exemplary blog application component of the online story sharing service that allows users to create and/or update a blog according to one embodiment;

FIG. 11 illustrates an exemplary application component of the online story sharing service that allows users to search for other users of the system according to one embodiment;

FIG. 12 illustrates an exemplary application component of the online story sharing service that displays the online friends of a registered user according to one embodiment;

FIG. 13 illustrates an exemplary profile application component of the online story sharing service according to one embodiment;

FIG. 14 illustrates an exemplary messaging application component that allows a user to communicate with online friends and/or other users of the online story sharing service according to one embodiment;

FIG. 15 illustrates an exemplary manage story application component of the online story sharing service that allows a user to manage their submitted stories according to one embodiment;

FIG. 16 illustrates an exemplary statistics application component of the online story sharing service that presents an aggregate of the statistics related to the stories the user has submitted according to one embodiment;

FIG. 17 illustrates an exemplary submit story application component of the online story sharing service that allows users to submit stories according to one embodiment;

FIG. 18 illustrates an exemplary contest leaderboard application component of the online story sharing service according to one embodiment;

FIG. 19 illustrates an exemplary story ranking chart that illustrates calculation of the contest scoring algorithm for a story contest according to one embodiment; and

FIG. 20 illustrates an exemplary computer system used in some embodiments.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A method and apparatus for an online story sharing service is described. The online story sharing service allows users to share stories with selected users (e.g., online friends) and/or with the general public. For example, a user may submit a story to the online story sharing service that is available to be viewed by selected users (e.g., online friends of the user) and/or by the general public or other registered users of the online story sharing service. As used herein, an online friend of a user is another user of the online story sharing service that is associated through the online story sharing service. Users may become online friends through an invitation process. Users of the online story sharing service may include registered users (users with accounts with the online story sharing service) and/or unregistered users. The online story sharing service includes one or more online communities. Each online community includes multiple users. For example, users may create and/or join one or more online communities. Users may be invited to join online communities and/or invite other users to join online communities. As another example, users may be part of the same online community through a relationship of work, school, or other real-world grouping. In some cases, a user may be part of several online communities at the same time.

The stories may be in a variety of formats including any combination of video stories, audio stories, image stories, and written stories. The stories may be submitted through an application component of the online story sharing service (e.g., website, screen of a mobile application, window of other application, etc.) and/or through other ways (e.g., email, text messages, multimedia messages, etc.). A particular story may include one or more components that are hosted by the online story sharing service and one or more components that are hosted by a different entity (e.g., a video sharing service) but capable of being presented through the online story sharing service. By way of a specific example, if the story has a textual component and a video component, the textual component may be hosted by the online story sharing service and the source of the video component may be hosted by a third party video sharing service (or other third party entity) but capable of being played through the online story sharing service.

In some embodiments, the online story sharing service conducts story contests whose winner(s) are determined by users of the online story sharing service. The winners of the contest are determined through a scoring system. For example, the scoring system may be based on one or more of the following: the number of views a story has during the contest, the number of comments on the story during the contest, the number of ratings on the story during the contest, and the average rating of the story during the contest. The contests may be conducted daily, weekly, monthly, and/or other length of time. In some embodiments, category or topic specific contests are conducted. Examples of categories include news, sports, travel, nightlife, food, celebrity, and funny. Of course these categories are examples and any grouping of stories may be used in embodiments of the invention described herein.

In some embodiments, the online story sharing service includes a social networking component that allows registered users to communicate with online friends (e.g., through online chat sessions, instant messaging, email, message board, private messages, blog, etc.) and share stories directly through the online story sharing service and/or with one or more external destinations (e.g., one or more email recipients, one or more text message recipients, one or more social networking websites, one or more microblogging services, one or more video sharing websites, etc.).

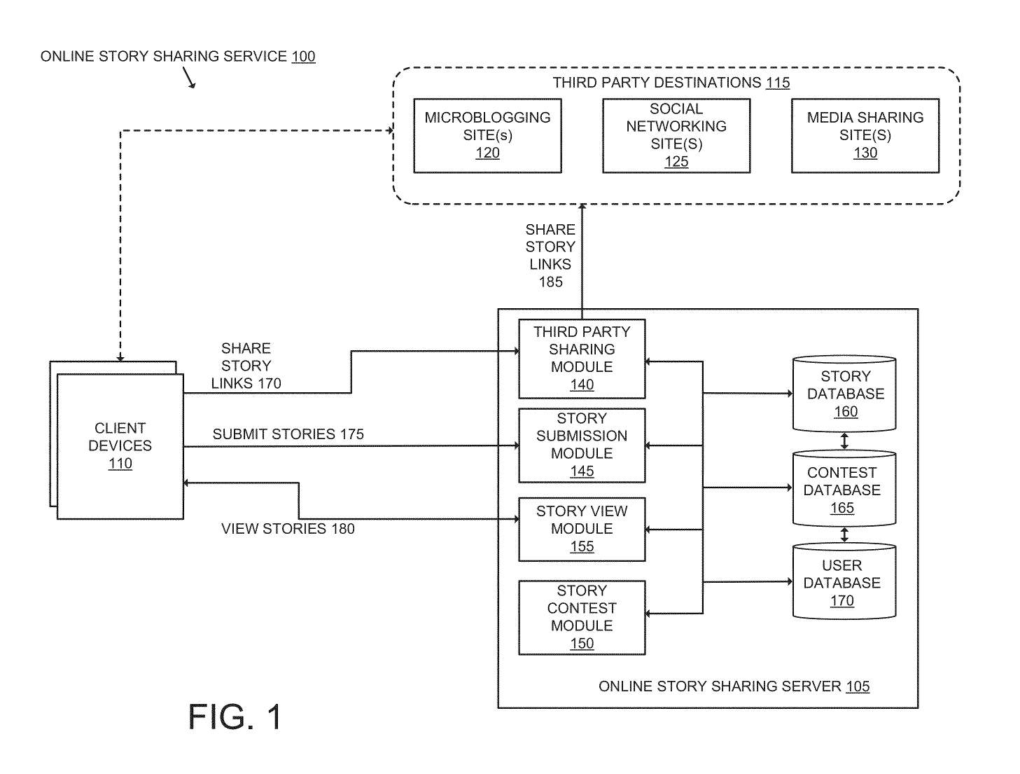

FIG. 1 illustrates an exemplary online story sharing service 100 according to one embodiment. The online story sharing service 100 allows users to share stories with selected users and participate in story contests. The client devices 110 (e.g., desktops, workstations, laptops, netbooks, palm tops, mobile phones, smartphones, portable media players, gaming systems, set-top boxes, or other devices that have network capability) are capable of accessing the online story sharing server 105 over a network (e.g., the Internet). By way of a specific example, the online story sharing server 105 includes a web server that delivers content of an online story sharing website to the client devices 110. The users of the client devices 110 may be registered users of the online story sharing service 100 (e.g., they have an account on the online story sharing server 105) or unregistered users.

The online story sharing server 105 provides much of the functionality of the online story sharing service 100. The story submission module 145 allows users of the client devices 110 to submit stories 175 to the online story sharing server 105. In one embodiment only registered users are permitted to submit stories while in other embodiments all users may submit stories. Each story may include a written component, a video component, an audio component, and/or an image component. The submitted stories are stored in the story database 160 or other suitable data structure. One or more components of each story may be hosted by a different entity than the online story sharing server 105. For example, a video component of a submitted story may be hosted by a third party video sharing service (e.g., one of the media sharing site(s) 130) but capable of being played through the online story sharing service.

The story view module 155 allows users of the client devices 110 to view submitted stories 180. It should be understood that a user is not required to submit a story in order to view other people's submitted stories. The story view module 155 also allows users to rate the stories (e.g., provide a quality rating of the story) and provide comments on the stories. The story view module 155 updates statistics associated with a particular story in the story database 160 (or other data structure associated with the story) each time the story is viewed, commented, or rated.

The third party sharing module 140 allows users to share links of submitted stories and/or viewed stories 170 (or in some cases the stories themselves) with one or more third party destinations 115. As illustrated in FIG. 1, example third party destinations 115 include one or more microblogging sites 120, one or more social networking sites 125, and one or more media sharing sites 130 (e.g., image and/or video sharing sites). Other third party destinations may include email recipients, text message recipients, and multimedia message recipients. In one embodiment, the third party sharing module 140 exposes one or more Application Programming Interfaces (APIs) for the third party destinations 115 that allows the users to share links of their submitted stories or viewed stories 185 with the third party destinations 115.

The story contest module 150 is configured to conduct story contests. Each story may be entered into one or more story contests. For example, a user may determine to enter their story into one or more story contests and/or stories may automatically be entered into one or more story contests. The story contest module 150 determines winner(s) of the contests through a contest scoring algorithm that is based on the average rating given by viewers of each submitted story along with the overall relative interest of each submitted story over the period of the contest. Multiple story contests may be running simultaneously. The contests may be conducted daily, weekly, monthly, and/or other length of time. Category or topic specific contests are conducted. In one embodiment, the winner(s) of a particular story contest are awarded a monetary reward (e.g., cash), a virtual currency reward that may be exchanged for real-world goods or services (e.g., gift certificates), and/or other non-monetary award(s) (e.g., a physical product, a service, an experience (e.g., a vacation, a concert, etc.), etc.). Information related to the story contests (e.g., the contest leaderboard, the winning stories, the currently leading stories, etc.) are stored in the contest database 165 or other suitable data structure.

Information related to the registered users of the online story sharing service 100 is stored in the user database 170 or other suitable data structure. For example, information for each user may include profile details (e.g., email address, social networking website username(s), microblogging service username(s), first and last name, gender, birthday, location, phone number, picture(s), etc.), submitted story statistics (e.g., the total number of views for all stories submitted by the user, the average number of views each story has received, the average rating of the stories submitted, an indication of the story most viewed, an indication of the highest rated story, and the total story contest earnings), online friend information (e.g., a list of the online friends of the user), and messaging information (e.g., unread messages, sent messages, archived messages, deleted messages, etc.).

Although not illustrated in order not to obscure understanding of the invention, the online story sharing server 105 also includes other functionality in some embodiments. For example, the online story sharing server 105 may include messaging component that allows users to communicate with other users via real-time communication (e.g., instant messaging, video chats, video conferences, etc.) and/or asynchronous communication (e.g., email, private messaging, text messaging, etc.). As another example, the online story sharing server 105 may also include a message board and/or blog component that allows registered users to post board entries and/or blog entries.

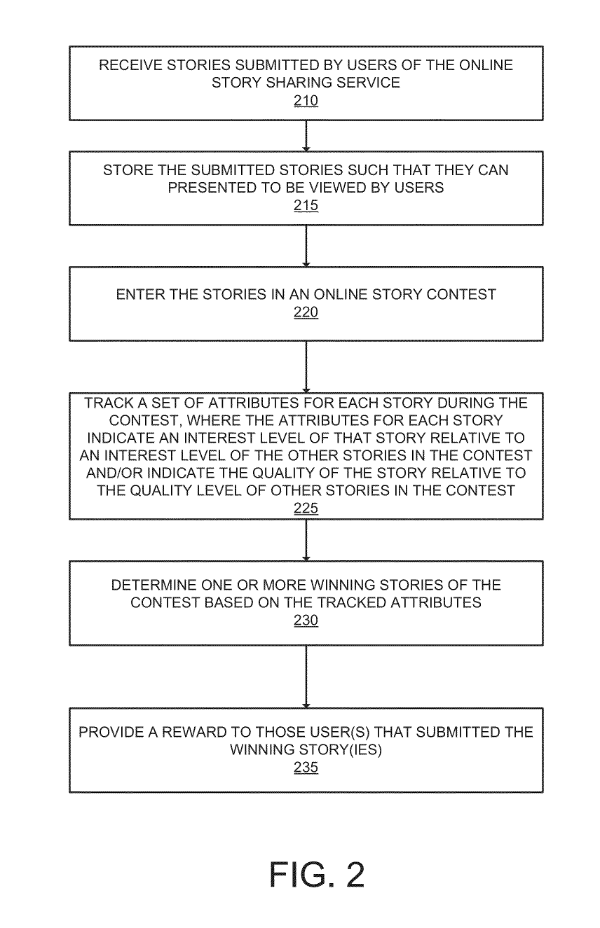

FIG. 2 is a flow diagram that illustrates exemplary operations for conducting an online story contest according to one embodiment. The operations of FIG. 2 will be described with reference to the exemplary embodiment of FIG. 1. However, it should be understood that the operations of FIG. 2 can be performed by embodiments of the invention other than those discussed with reference to FIG. 1, and the embodiments discussed with reference to FIG. 1 can perform operations different than those discussed with reference to FIG. 2.

At operation 210, the online story sharing server 105 receives stories submitted by users of the online story sharing service. For example, users of the client devices 110 submit stories through use of the story submission module 145. Each submitted story includes one or more of a written component, an audio component, an image component, and a video component. Flow then moves to operation 215.

At operation 215, the online story sharing server 105 stores the submitted stories such that each story may be presented to a user of the online story sharing service upon request. For example, the story submission module 145 causes the submitted stories to be stored in the story database 160. In addition, for each story submitted, the story submission module 145 indicates in the user database 170 which user submitted that story. Upon receipt of request to view a story, the story view module 155 accesses the story from the story database 160 and presents the story to the requesting user and may also provide functionality for the user to submit a comment on the story and/or rate the story. Flow then moves to operation 220.

At operation 220, the online story sharing server 105 enters one or more of the received stories into an online story contest. The online story contest is configured to operate for a predetermined duration of time (e.g., daily, weekly, monthly, or other length of time). For example, in one embodiment, the users that submitted the stories indicate whether they want their story(ies) to be entered into an online story contest. In another embodiment, each story is automatically entered into an online story contest unless the user that submitted that story indicates that he or she does not want to participate in a story contest. The story contest module 150 causes a record of the stories that are entered into the online story contest to be stored in the contest database 165. Flow moves from operation 220 to operation 225.

At operation 225, the online story sharing server 105 tracks a set of attributes for each story during the online story contest. The set of attributes that are tracked for each story include parameters that indicate an interest level of that story relative to the interest level of the other stories. By way of a specific example, the story view module 155 updates statistics associated with a particular story in the story database 160 (or other data structure associated with the story database 160) each time that story is viewed, commented, and/or rated. The story contest module 150 tracks, for each story in the story contest, a set of attributes of the story that indicate an interest level of the story relative to other stories in the contest and/or indicate the quality of the story relative to the other stories in the contest. For example, the attributes include one or more of the following: the number of views a story has during the contest, the number of comments on the story during the contest, the number of ratings on the story during the contest, and the average quality rating assigned by viewers of the story. Flow then moves to operation 230.

At operation 230, the online story sharing server 105 (e.g., the story contest module 150) determines one or more winning stories of the contest based on the tracked attributes. The tracked attributes are attributes associated with involvement of the users of the online story sharing service (e.g., based on the number of views, comments, ratings, etc.). Thus, the users of the online story sharing service determine the winner(s) of the contest. The story contest module 150 causes the results of the story contest to be stored in the contest database 165.

Flow moves from operation 225 to operation 230 where the online story sharing server 105 provides a reward to those user(s) that submitted the winning story(ies). In one embodiment, the winner(s) of the contest are awarded a monetary reward (e.g., cash), virtual currency reward that may be exchanged for real-world goods or services (e.g., gift certificates), and/or other non-monetary award (e.g., a physical product, a service, an experience (e.g., a vacation, a concert, etc.), etc.). By way of example, the online story sharing server 105 causes a bank account, payment account, or other account of a user that submitted a winning story to be credited with the reward. As another example, the online story sharing server 105 causes a check or other reward to be sent to the address of a user that submitted a winning story. The reward may be different for different winning stories. For example, the first place winning story may receive a reward of a higher value than the second place winning story and so on. A record of the reward(s) provided to a user is stored in the user database 170.

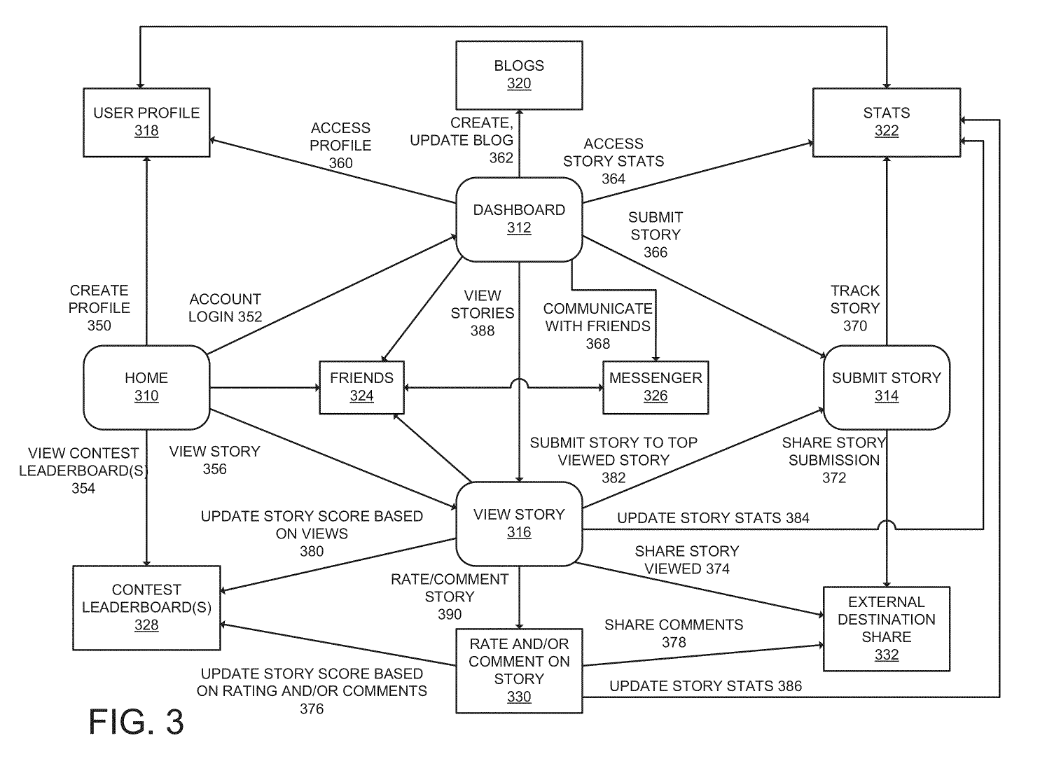

In one embodiment, the online story sharing service is provided through an online application (e.g., a website, a mobile application, or other application software). FIG. 3 illustrates a logical representation of an exemplary application for the online story sharing service described herein according to one embodiment. FIG. 3 illustrates logical components of the application, which may be implemented and presented with one or more application components (e.g., web page(s), screen(s) of a mobile application, window(s) of application software, etc.). A user typically accesses the story sharing application from the home application component 310 (e.g., homepage, home screen, etc.). The home application component 310 allows users to access stories and other components of the site. For example, from the home application component 310, the user can create a profile 350, login to an existing account 352, view contest leaderboard(s) 354, and view story(ies) 356. Although not illustrated in FIG. 3, the home application component 310 may also allow users to submit stories. In one embodiment only registered users are permitted to submit stories to the system, while in other embodiments registered and unregistered users are permitted to submit stories.

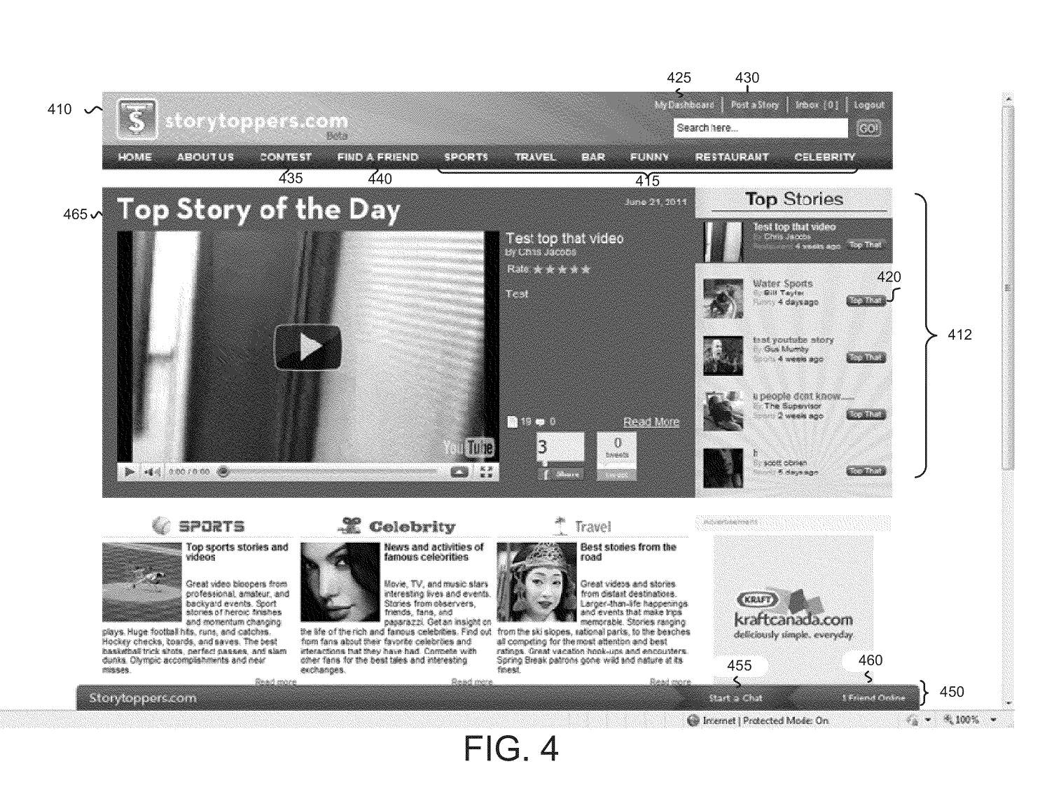

FIG. 4 illustrates an exemplary home application component 410 according to one embodiment. The home application component 410 and other application components illustrated in FIGS. 4-19 are in the form of web pages. However, it should be understood that the home application component 410 and other application components illustrated in FIGS. 4-19 may be implemented as other types of application components (e.g., screen(s) of a mobile application, window(s) of other application software, etc.).

The home application component 410 allows users to access stories and components of the site in multiple ways. For example, the application component 410 allows a user to view the top stories listed in section 412, select story categories and/or sub-categories from the story categories 415 (e.g., sports, travel, bar, funny, restaurant, celebrity), comment on stories seen, rate stories seen, submit stories (e.g., by selecting the “Top That” object 420 causing a submit story application component to be presented, which will be described in further detail later herein), and share stories with external destinations. The home application component 310 also provides a brief description of the categories.

The home application component 410 also presents the top story of the day 465. In one embodiment, the top story of the day is the top current story of the day (e.g., the story that is currently leading an ongoing online story contest). For purposes of calculating the score for the story contest, the top story of the day 465 will not be counted as being viewed until and unless a viewer selects the story to view (e.g., to play the video, to hear audio, to view images and/or text of the story). In another embodiment, the top story of the day is a most recent winner of an online story contest.

The home application component 410 also allows a user to create an account, log-in to an existing account, post a story (e.g., through selection of the Post a Story object 430), access a user's personal dashboard (e.g., through selection of the My Dashboard object 425), access story contest leaderboards and lists of past winners (e.g., through selection of the Contest object 435), and search for users that have an account with the system (e.g., through selection of the Find a Friend object 440).

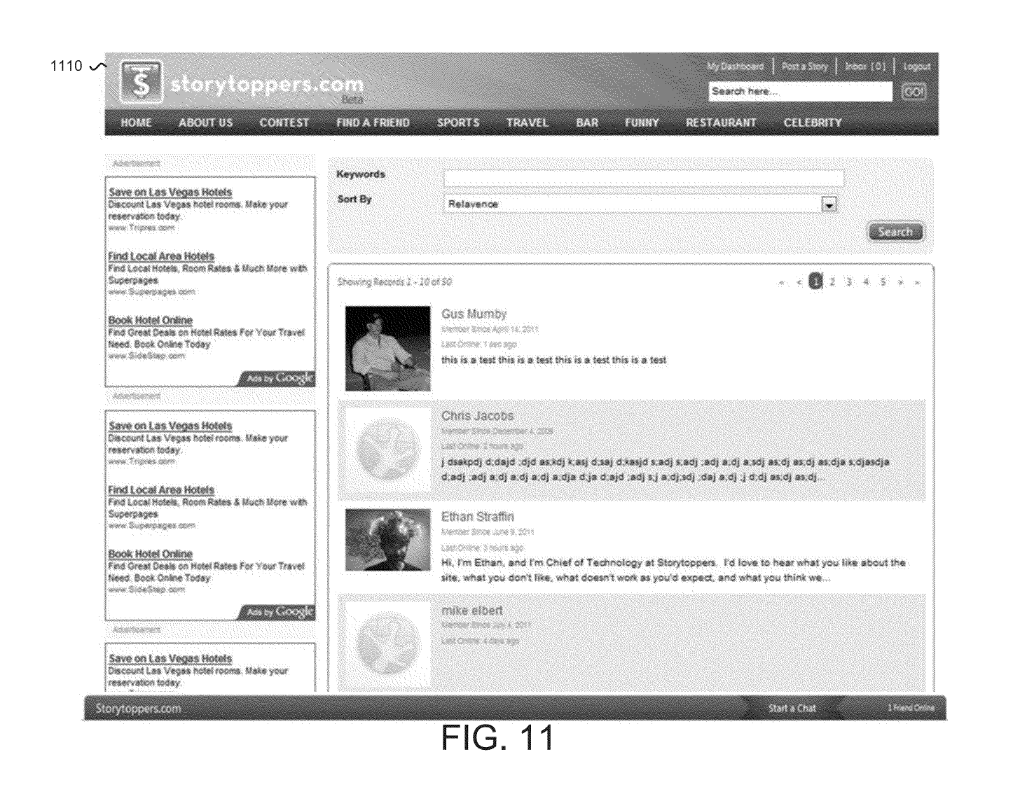

The object 440, which when selected by a user, causes an application component to be presented to the user that allows the user to view users of the system, for example in order to search for possible users to invite as online friends. FIG. 11 illustrates an exemplary application component 1110 that allows users to search for other users of the system. Users may search the friends database to based on keywords (e.g., name, location, interests, etc.) to search for possible friends. The results of a user search are presented by the application component 1110 with user(s) that match the keywords. A user can select on any other user to view their profile and/or cause an online friend request to be sent to that user. The user that has been friend requested will be sent a notification to respond to the request (accept or deny the friend request).

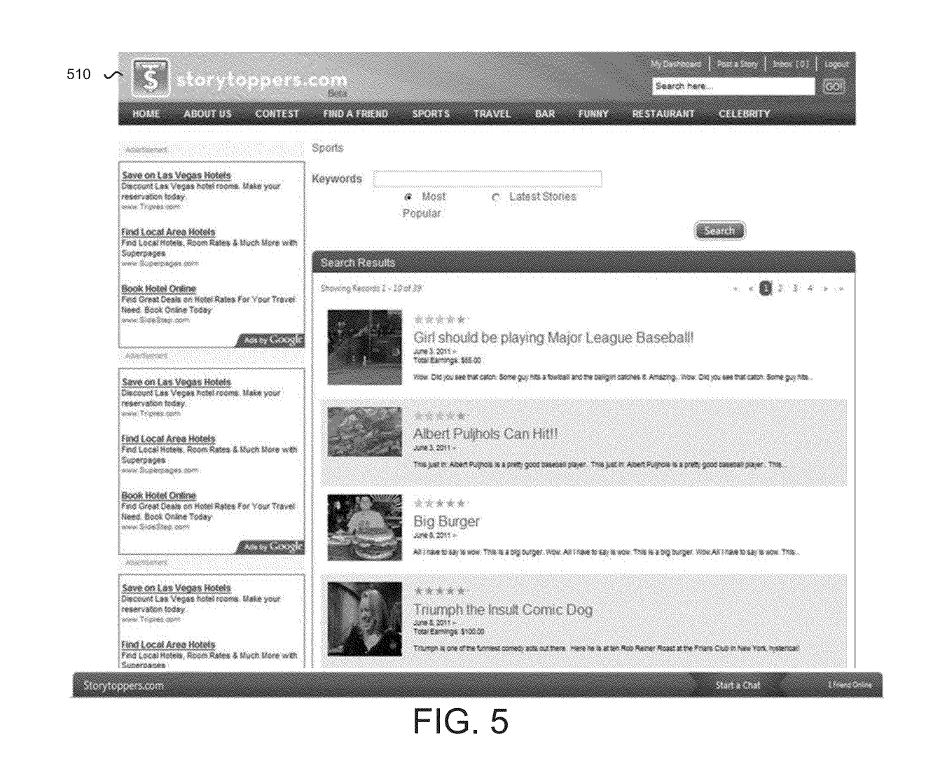

FIG. 5 illustrates an exemplary story search application component 510 that is presented responsive to a user selecting one of the categories 415 according to one embodiment. The story search application component 510 allows users to search for stories in a particular category and/or subcategory based on keywords. The story search application component 510 allows the user to select to view the most popular stories (e.g., as determined by the total views of the story) or the latest stories in the category.

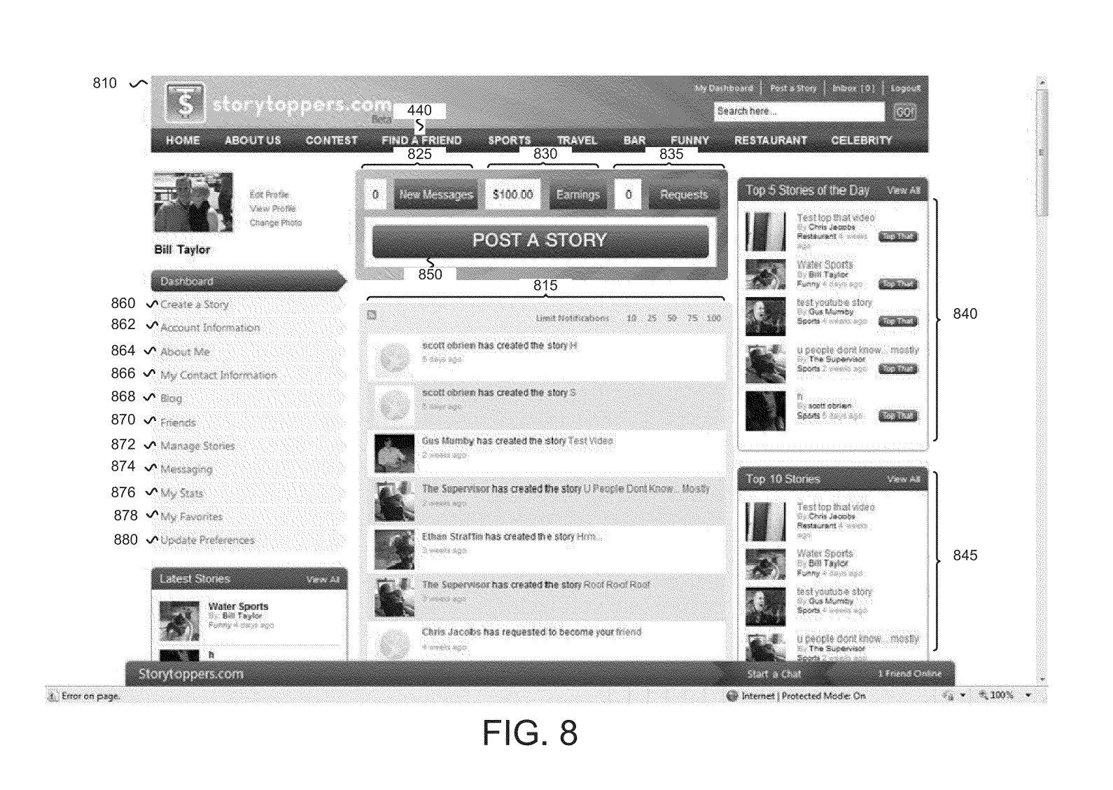

Assuming that a user has logged into the system, the home application component 410, as well as other application components illustrated in FIGS. 8-18 include a messaging object 450 that indicates the current number of friends that are currently online in section 460 and includes an object 455 that, when selected by a user, causes a messaging application component to be presented to the user to allow the user to engage in messaging with one or more of their online friends (either currently online or currently offline).

Referring back to FIG. 3, the view story application component 316 allows users to view stories, submit stories to top a viewed story 382 through use of a submit story application component 314, rate and/or comment a story 390 through a rate/comment component 330, share a viewed story 374 and/or comments of the story 378 with one or more external destinations (e.g., one or more email recipients, one or more text message recipients, one or more social networking websites, one or more microblogging services, one or more video sharing websites, etc.) through an external destination share application component 332. In one embodiment, the external destination share application component 332 leverages an Application Programming Interface (API) provided by an external destination to share a story and/or comments of the story with that external destination.

Each unique story view causes the story statistics for that story to be updated 384 with an updated view count. The statistics are associated with the profile of the user that submitted the story and may include, among other items, the total number of views for all stories submitted by the user and the average number of views each story has received.

In embodiments where the story view count is used in a scoring system to determine winner(s) of a story contest or otherwise the relative popularity of the story, the story score is updated based on the views of the story 380, which may be limited for each viewer. For example, in some embodiments, regardless of the actual number of times the story is viewed by a particular viewer, only one view (or other limited number of views) of that viewer is used when calculating the popularity score for purposes of the contest. In such a manner, the integrity of the story contest system is maintained. A particular viewer may be identified through its IP address and/or user account according to one embodiment.

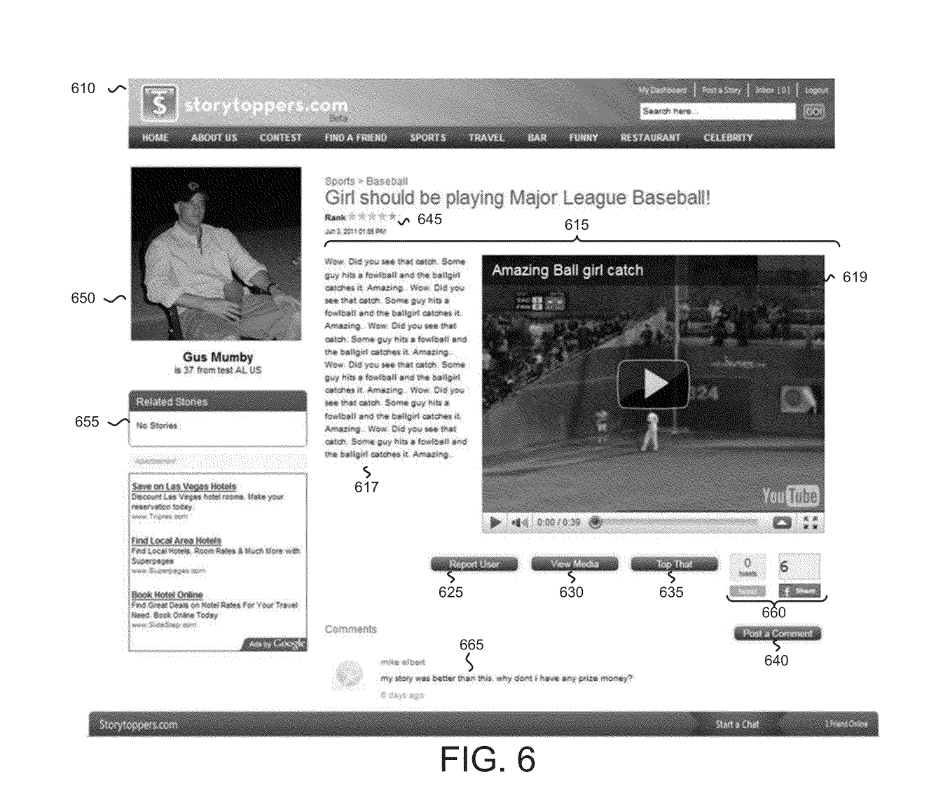

FIG. 6 illustrates an exemplary view story application component 610 according to one embodiment. The view story application component 610 is displayed responsive to a user selecting a story to view. For example, with reference to FIG. 4, responsive to selecting one of the stories in the top stories list 412, the view story application component 610 is presented to the user with content corresponding to the selected story.

The view story application component 610 displays the title of the story, the current ranking of the story 645, the story content 615, as well as an indication of the user that posted the story 650. The story content may include one or more of the following: a textual component, an audio component, a video component, and an image component. As illustrated in FIG. 610, the presented story includes a textual component 617 and a video component 619. The content of the story may at least be partially hosted by a different entity than the online story sharing service. For example, the video component 619 may be hosted by a third party video sharing website and embedded into the view story application component 610 such that it appears to be playing directly from the view story application component 610.

The view story application component 610 includes a report user object 625 that allows users to report the story as being inappropriate. By way of example, responsive to a user selecting the report user object 625, an application component is presented to the user that allows the user to provide an explanation for why the story was reported as being inappropriate. A story may be reported as being inappropriate for a number of reasons. For example, a copyright owner may report a story if the story was submitted by an unauthorized party. As another example, a story may be reported as being inappropriate if it contains objectionable content (e.g., adult content, vulgarity, etc.), if it is in the wrong category, etc. A review procedure is conducted after a story is reported as being inappropriate. If a story is determined to be inappropriate, it will be edited or removed from the online story sharing service. A user of the system may be banned if it submits inappropriate material.

The view story application component 610 further includes a view media object 630 that, when selected by a user, presents to the user additional media related to the story (e.g., image(s), video(s), audio clip(s), etc.).

The online story sharing service encourages users to compete to submit the best stories. In some embodiments, associated with each story, a “Top That” object is presented to the viewer, which when selected, allows the viewer to submit their own story in an attempt to top the viewed story. In one embodiment, upon selection of the “Top That” object, the category and/or sub-category information of the viewed story corresponding to the “Top That” object is automatically populated by the system (which may not be able to be changed by the user) such that the story to be submitted will be in the same category and/or sub-category as the story being displayed. For example, the view story application component 610 includes the Top That object 635 that, when selected by the viewer, allows the viewer to submit a story in an attempt to top the viewed story.

In one embodiment, responsive to a user submitting a story in an attempt to top a story, a notification is communicated to the user that submitted the story that is being challenged. For example, an email, text message, or other message may be transmitted to the user that submitted the original story that indicates that a story has been submitted to top their story. As another example, in addition to or in lieu of transmitting a message to the user, a notification may be stored in an inbox of the user that submitted the original story of a messaging application component of the online story sharing service that indicates that a story has been submitted to top their story.

Submitting a story in an attempt to top a story that is currently in a story contest may automatically cause that story to be entered into the same story contest. However, if the duration of the story contest is near its completion, then in some circumstances the newly submitted story will be entered into the next contest.

The related stories section 655 displays a list of stories that are related to the viewed story. A related story is a story that has been submitted to top a viewed story. For example, if the story being viewed was posted as a result of a user trying to top another story, that other story will be indicated in the related stories section 655. As another example, if another user has posted a story to top the story being viewed, that other story will be indicated in the related stories section 655.

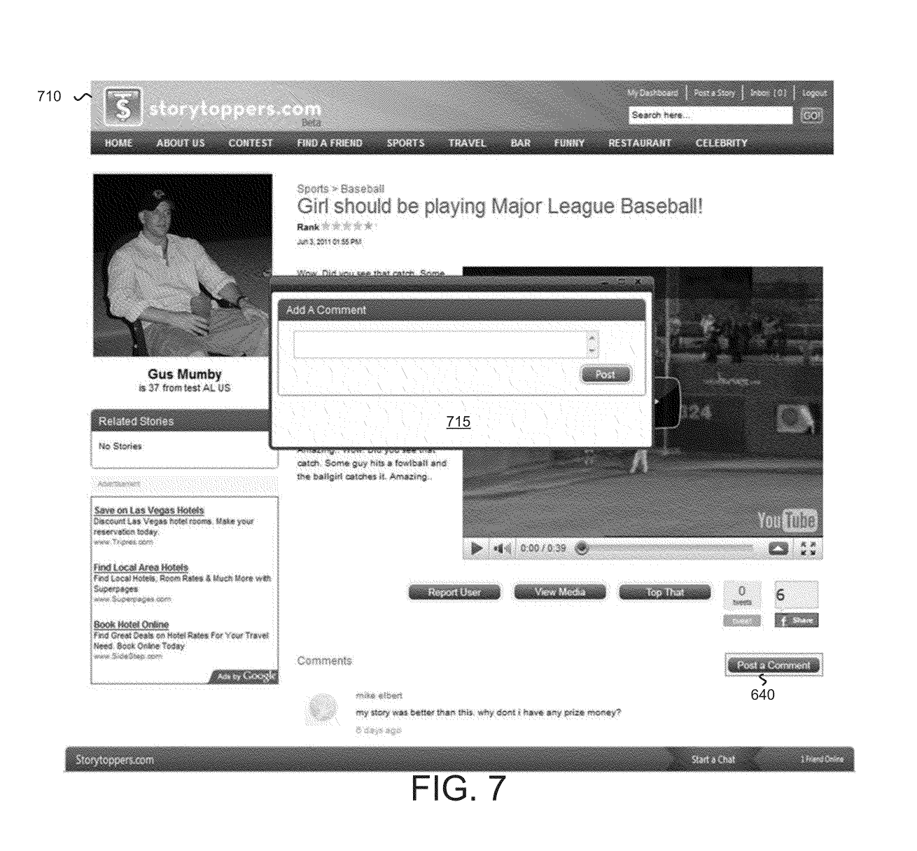

Viewers of a story may post a comment of that story using the post a comment object 640 of the view story application component 610. FIG. 7 illustrates a comment application component 710 that is displayed responsive to a user selecting the post a comment object 640 according to one embodiment. The comment application component 710 includes an object 715 to allow the user to input and post a comment. In one embodiment, only registered users are permitted to post comments, while in other embodiments any user can post comments. In some embodiments, to reduce spam or other irrelevant postings the user may need to successful pass a CAPTCHA test in order to post a story comment. The posted comments are displayed in the comments section 665 of the view story application component 610.

In one embodiment, viewers of the story can rate the story. For example, the view story application component 610 displays the rating of the story 645. When the story is initially presented to the viewer, the displayed rating reflects the current overall rating of the story. A viewer can rate the story using the using the displayed rating in some embodiments. For example, a viewer can select the number of stars to submit their own rating for the story. After the user scrolls away from the rating, the rating reverts back to the overall rating, which may be changed to reflect the viewer's rating. As illustrated in FIG. 6 the rating is illustrated as a number of stars, however it should be understood that this is exemplary as other mechanisms for displaying and representing the story rating may be used in embodiments described herein.

The viewers of a story may also share the story with one or more external destinations (e.g., one or more email recipients, one or more text message recipients, one or more social networking websites, one or more video sharing websites, etc.). For example, the view story application component 610 includes the sharing objects 660 that, when each selected, present an external destination share application component that allows the user to share the story with a microblogging service (e.g., a link of the story is posted to a microblogging account of the viewer) and/or with a social networking website respectively (e.g., a link is posted to a notifications area of an social networking account of the viewer, a link is posted to a notifications area of a social networking account of an online friend of the viewer, etc.). The viewer may also share the comments associated with the story and/or share comments of the viewer or otherwise provide a short description of the story. Sharing links to the story and/or comments of the story with existing social networking services and other online services increases the exposure of a story and furthers the possibility that the story will go viral and win a story contest.

The user that posted the story is indicated through the section 650 of the view story application component 610. In some embodiments, the user can configure the information related to its profile that is displayed when their story is viewed. For example, the user may not share a picture, name, location, age, etc.

With reference back to FIG. 3, in one embodiment, a user logging into the system causes a dashboard application component 312 that is personalized for the user to be displayed. For example, with respect to FIG. 4, responsive to the user selecting the My Dashboard object 425, the user is queried to present login credentials. Assuming that the login credentials are valid, a personalized dashboard application component 312 is presented to the user. The personalized dashboard application component 312 allows a user to, among other things, access their profile 360 and/or edit their profile through use of a user profile application component 318, view the stories 388 that the user has submitted and/or the stories that have been submitted by online friends 324 through use of the view story application component 316, communicate with online friends (or prospective online friends) 368 through use of a messaging application component 326 (e.g., through instant messaging, email, message board, private messaging, etc.), create and/or update a blog 362 through use of a blog application component 320, access statistics of stories submitted by the user 364 through use of a statistics application component 322, and submit story(ies) 366 through the use of a submit story application component 314.

FIG. 8 illustrates an exemplary personalized dashboard application component of the online story sharing service according to one embodiment. For example, the personalized dashboard application component 810 is displayed responsive to a user selecting the My Dashboard object 425 illustrated in FIG. 4 and providing valid credentials. As illustrated in FIG. 8, the dashboard page 810 includes a section 815 that displays notifications of actions taken by online friends or prospective online friends. Examples of actions for which notifications are displayed include creating and/or submitting a story, sharing a story, creating and/or updating a blog, receiving online friend requests, receiving community invitations, etc. By way of example, a notification that indicates that an online friend has submitted a story includes a link to that story.

The personalized dashboard application component 810 also includes a section 840 that lists a set of top stories of the day as well as a section 845 that lists a set of top stories that have been submitted to the site (e.g., all-time top stories, stories of the year, etc.). The stories listed in the section 840 also include a “Top That” button that, when selected by a user, causes a story submission application component to be displayed to the user. As will be described in greater detail later herein, in one embodiment, selection of a “Top That” object automatically populates one or more fields of the story submission application component (e.g., the category, the sub-category, etc.) such that the story to be submitted will be in the same category and/or sub-category as the story being displayed.

The personalized dashboard application component 810 also indicates the number of new messages for the user 825 (e.g., through use of a messaging feature of the system), the amount of earnings 830 won by the user, and the number of online friend requests 835 (and/or other community invitations) of the user that are currently pending.

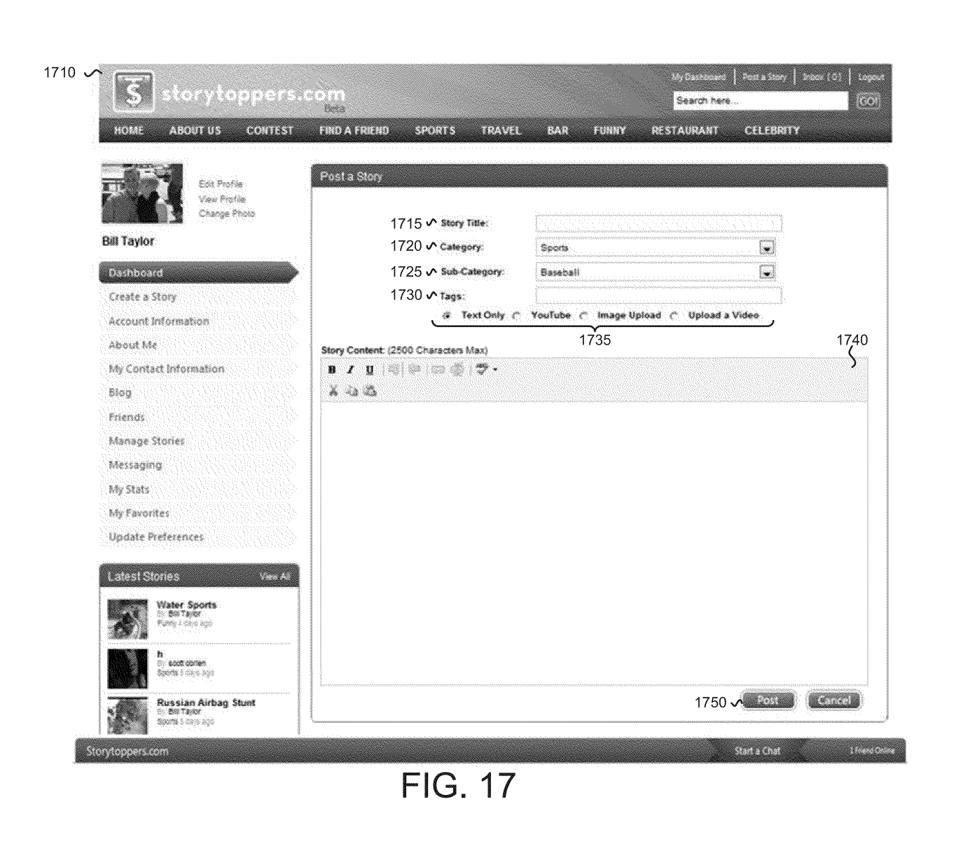

The personalized dashboard application component 810 also includes a story posting object 850 to allow the user to post a story to the system. For example, responsive to the user selecting the story posting object 850, an application component is presented that allows the user to post a story to the online story sharing service. An exemplary submit story application component will be described in greater detail with respect to FIG. 17.

The personalized dashboard application component 810 also includes a number of other objects, that when selected by a user, causes another application component to be presented to the user. For example, the personalized dashboard application component 810 includes the object 860, which when selected by a user, causes an application component to be presented to the user that allows that user to post a story to the online story sharing service.

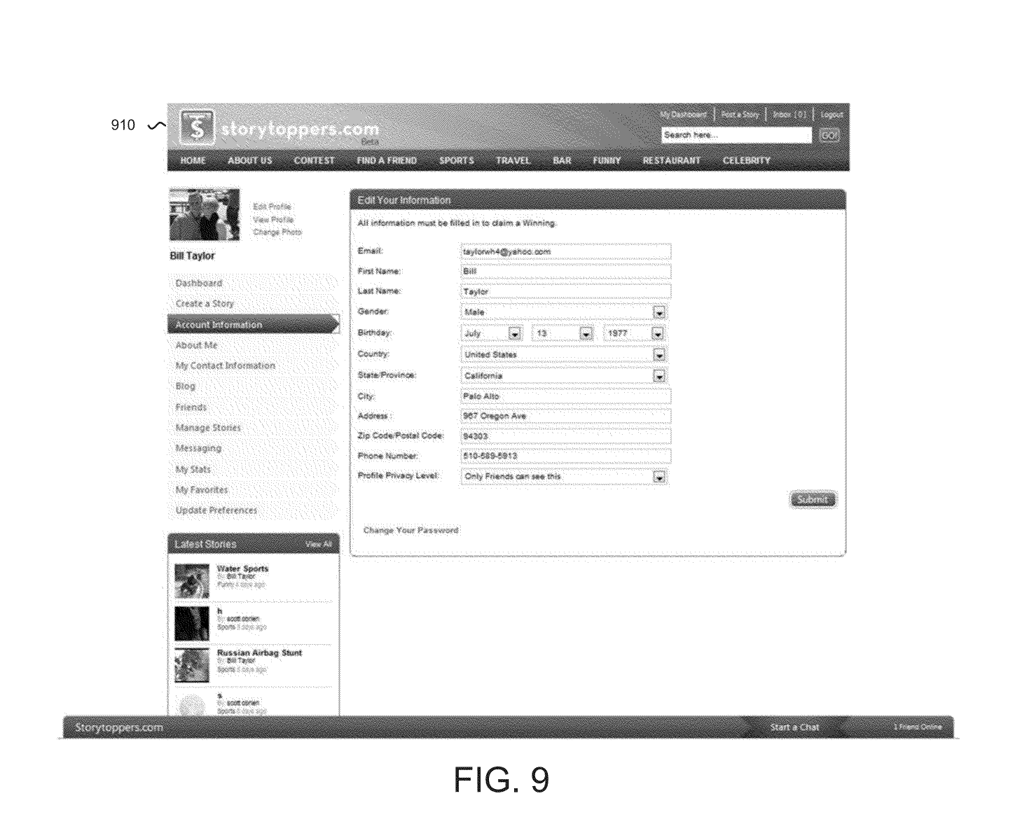

The object 862, which when selected by a user, causes an application component to be presented to the user that displays account information of the user. For example, FIG. 9 illustrates an exemplary application component 910 that allows a user to view and/or edit their account information. For example, the user may provide an email address, first and last name, gender, birthday, and location. The user may also configure a username of the online story sharing service. In some embodiments, in order to claim a reward or prize of a story contest, the user is required to have a valid email address, first and last name, gender, birthdate (e.g., over the legal age of the jurisdiction), and location.

The object 864, which when selected by a user, causes an application component to be presented to the user that allows the user to view and/or edit information about the user (e.g., a brief description of the user). The object 866, which when selected by a user, causes an application component to be presented to the user that allows the user to view and/or edit contact information of the user.

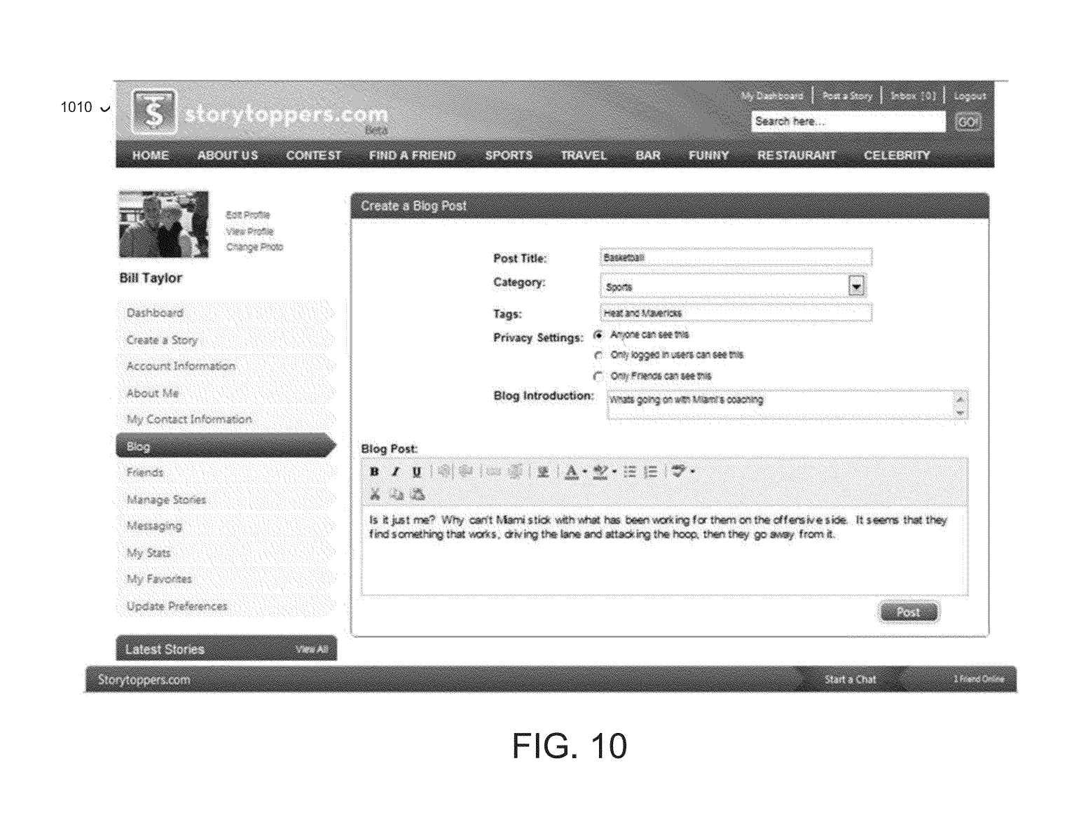

The object 868, which when selected by a user, causes an application component to be presented to the user that allows the user to view and/or edit a blog of the user and/or blog(s) of online friends of the user. For example, FIG. 10 illustrates an exemplary blog application component 1010 that allows users to create and/or update a blog. The blog (or certain entries of the blog) may be private to one or more online communities or generally accessible to any user of the online story sharing service (which may be configurable by the user). Other users that have access to the blog may post comments on each blog entry.

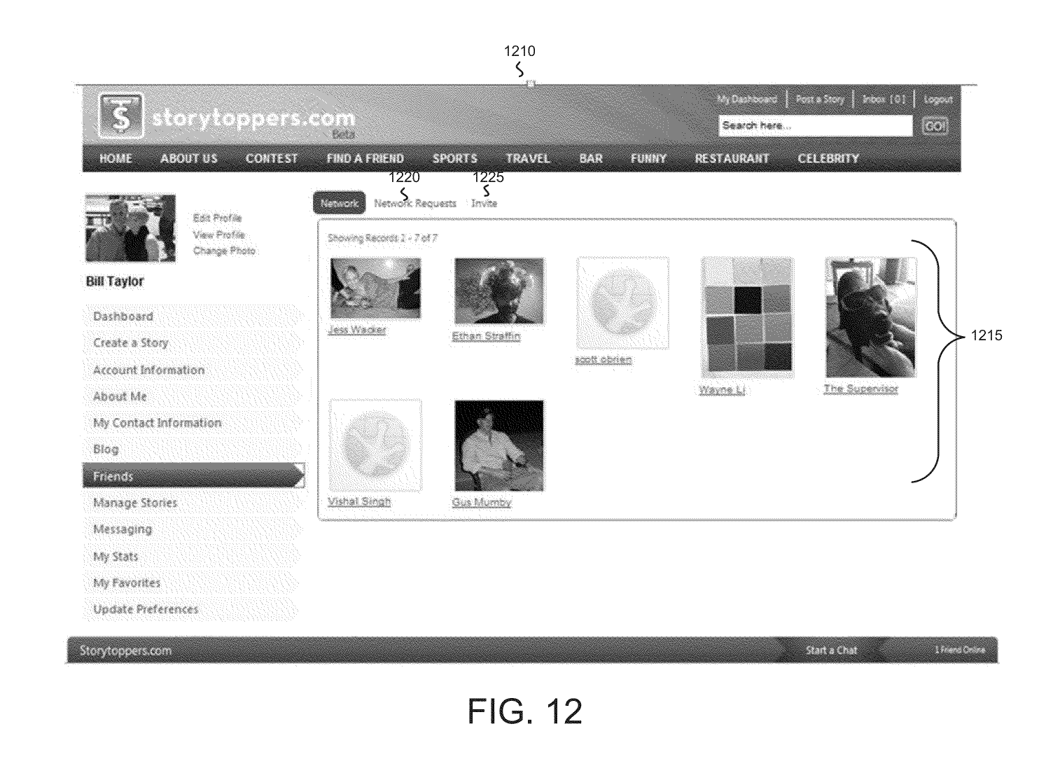

The object 870, which when selected by a user, causes an application component to be presented to the user that allows the user to view their online friends and/or invite users to be friends. For example, FIG. 12 illustrates an exemplary application component 1210 that displays the online friends of a registered user in the friends list 1215. Each online friend is represented as an object, that when selected, a profile application component of the online friend is presented that displays profile information of the friend (e.g., contact information, online friends, blog entry(ies), latest story submission(s), location, birthdate, total amount of earnings from story submissions won by the user, etc.).

The user may also invite other users to be friends using the application component 1210. For example, responsive to selection of the object 1225, an invitation application component is presented to the user that allows the user to invite one or more users to be online friends or to be part of the same community. The user may also view incoming friend requests through selection of the object 1220.

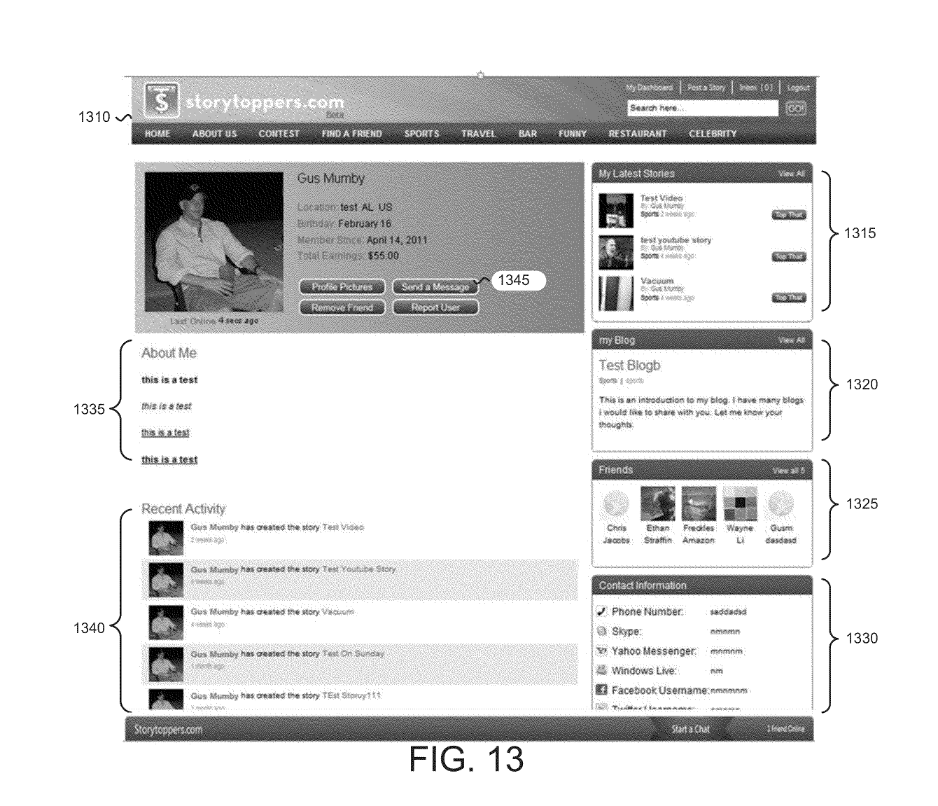

FIG. 13 illustrates an exemplary profile application component 1310 according to one embodiment. The profile application component 1310 includes a latest stories section 1315 that displays a list of the latest stories submitted by the user, a blog section 1320 that displays one or more blog entries of the user, an online friends section 1320 that displays the online friends of the user, a contact information section 1315 that displays contact information of the user, an about me section 1335 that displays biographical or other information that the user would like to display, and a recent activity section 1340 that displays the recent activities of the user. The recent activities may include posting a story, viewing a story, posting a blog entry, adding an online friend, updating profile information, etc.

The contact information section 1330 may display one or more of the following of the user: email address(es), phone number(s), address(es), instant messenger username(s), microblogging username(s), social networking site username(s), or other communication application user information. Due to space limitations, the profile application component 1310 may display a subset of the story postings of the user in section 1315, a subset of the blog entries of the user in section 1320, and/or a subset of the friends of the user in the friends section 1325. These can be further expanded by selection of a view all object or other object that causes an application object that presents all (or at least more) of the objects.

The profile application component 1310 also includes an object 1345, that when selected, causes a messaging application component to be presented that allows a message to be created and sent to the user corresponding to the profile. The messaging application component may allow for real-time communication (e.g., instant messaging, video chats, video conferences, etc.) or asynchronous communication (e.g., email, private messaging, text messaging, etc.). The messaging application component may allow the user to access their prior communications (a history of their communications) and/or continue any past prior communications (e.g., respond to an email).

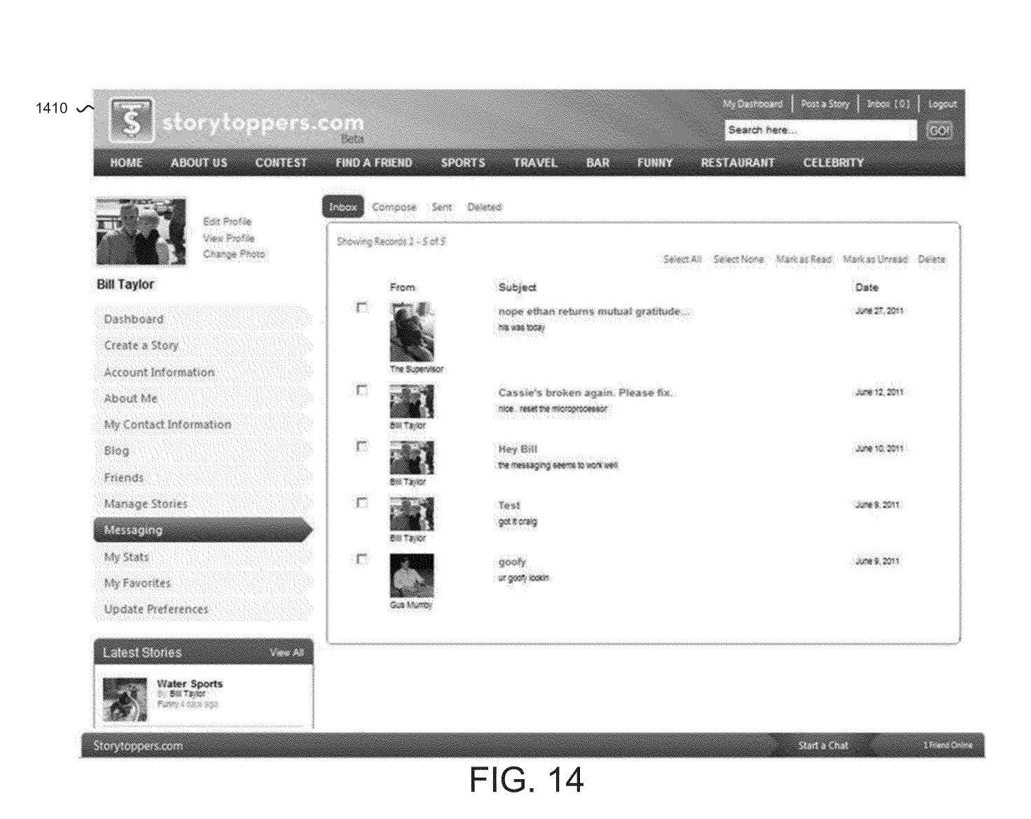

FIG. 14 illustrates an exemplary messaging application component 1410 that allows a user to communicate with online friends and/or other users of the online sharing service. The messaging application component 1410 may be presented responsive to selection of the object 1345. As illustrated in FIG. 14, the messaging application component 1410 includes an inbox of messages that have been received by the user. The user may also compose messages to be sent to other users of the online story sharing service, view sent messages, and view deleted messages.

Although not illustrated, in one embodiment, upon receipt of an instant message or other form of real-time communication, an application component is presented that displays the message. This application component may allow the user to reply to the message or otherwise participate in the communication.

In one embodiment, the content displayed in the profile application component 1310 is customizable according to the preferences of the user. For example, the user may configure their profile so that their recent activity, latest stories, blog entries, online friends, and/or contact information is not displayed or is displayed only to selected users (e.g., online friends). The display options may also be customized for different communities.

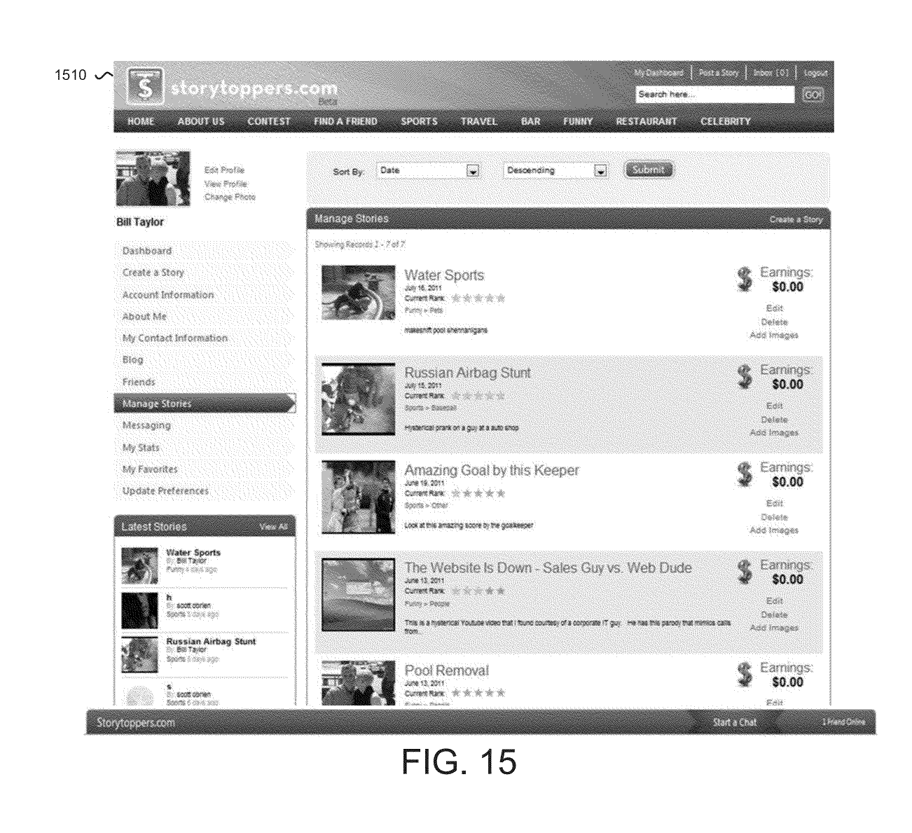

Referring back to FIG. 8, the object 872, which when selected by a user, causes a manage story application component to be presented to the user that allows the user to manage their submitted stories (e.g., update or change stories that have been created and submitted by the user). For example, FIG. 15 illustrates an exemplary manage story application component 1510 that allows a user to manage their submitted stories. The stories that have been submitted by the user can be sorted (e.g., by submission date, title, etc.). The user can use the application component 1510 to view their stories, the current rank of their stories, view their story earnings (e.g., if the story earned money in a story contest, as will be described in greater detail later herein), edit their stories (e.g., change/add/remove content of stories, change story category and/or sub-category, change title of stories, change/add/remove the upload source of the story (e.g., if a video component of the story is hosted on a separate server)), and delete the stories. Although not illustrated in FIG. 15, in one embodiment the application component 1510 also allows users to submit one or more of their stories to one or more story contests.

The object 874, which when selected by a user, causes a messaging application component to be presented to the user that allows the user to communicate with online friends and/or other users of the online story sharing service through a messaging feature of the system. The messaging application component may allow for real-time communication (e.g., instant messaging, video chats, video conferences, etc.) or asynchronous communication (e.g., email, private messaging, text messaging, etc.). For example, in one embodiment, selection of the object 874 causes the messaging application component 1410 to be presented to the user.

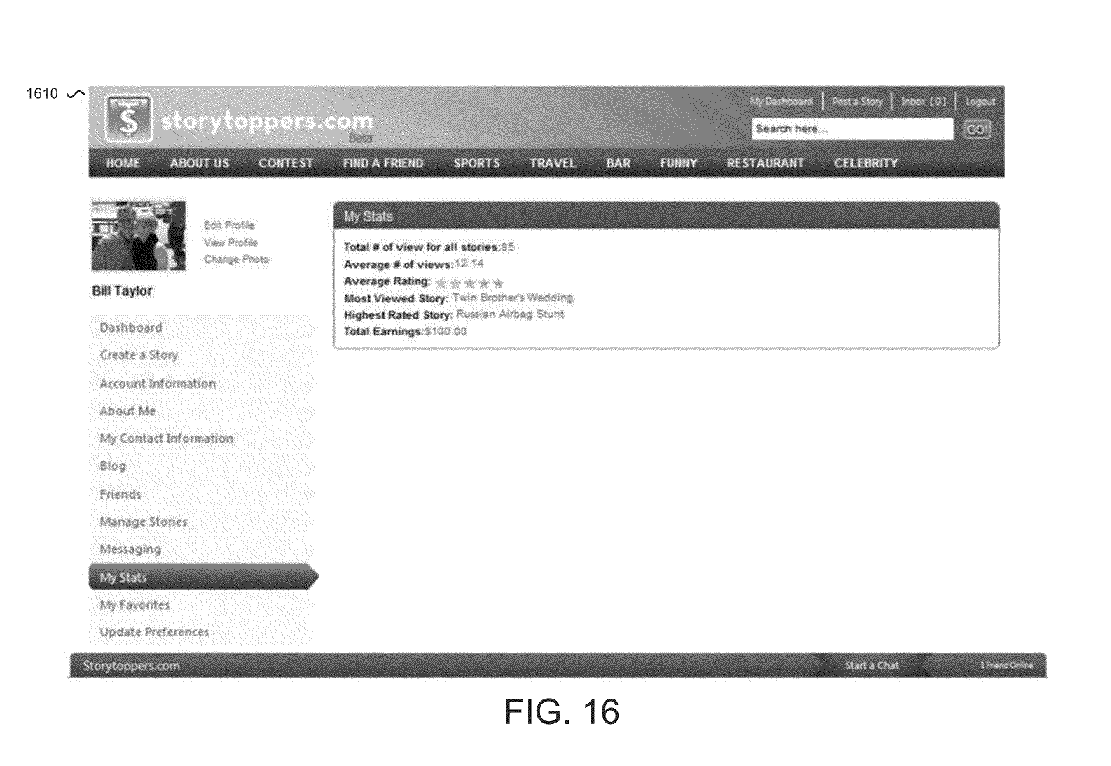

The object 876, which when selected by a user, causes a statistics application component to be presented to the user that allows the user to view statistics related to stories the user has submitted. For example, FIG. 16 illustrates an exemplary statistics application component 1610 that presents an aggregate of the statistics related to the stories the user has submitted. By way of example, the statistics that may be displayed include the total number of views for all stories submitted by the user, the average number of views each story has received, the average rating of the stories submitted, an indication of the most viewed story, an indication of the highest rated story, and the total story contest earnings.

The object 878, which when selected by a user, causes a favorite story application component to be presented to the user to allow the user to view and/or edit story favorites. In one embodiment, the stories that the user has given the highest rating to (as compared with other stories the user has viewed and/or rated) are automatically added as story favorites. In other embodiments, a story is chosen as a favorite by the user. In some embodiments, the story favorites of a user can be viewed by online friends of the user. The favorites may also include any story that the user has given the highest rating allowed by the system (e.g., a five out of five star rating). The favorite story application component may also allow the user to edit which stories are their favorites (e.g., add stories to their favorites, remove stories from their favorites, etc.).

The object 880, which when selected by a user, causes a web page or other interface to be presented to the user to allow the user to view and/or edit preferences of the user. For example, a user can set preferences including privacy settings and/or alert settings. The user may configure privacy settings to establish what, if any of the user's profile information (e.g., email address, name, social networking website username(s), microblogging service username(s), gender, birthday, location, phone number, picture(s), etc.) is publicly visible or visible only to online friends. The user may configure alert settings to establish how and/or when a user is to be notified about relevant updates to a stories (e.g., by email, text message, etc.). Examples of relevant updates may include the following: the story moving into a winning position in a story contest (or moved to a predefined number within or top of the leaderboard), the story moving out of a winning position in a story contest (or moved out from a predefined number within the top of the leaderboard), the story won a story contest, the story did not win a story contest, the story contest in which the story was entered is over, the story being challenged by another story, and/or the story was reported as containing inappropriate material.

With reference back to FIG. 3, the online story sharing service includes a submit story application component 314 that allows users to submit stories to the online story sharing service (which may include submitting stories to be part of a story contest) and share submitted stories 372 with one or more external destinations (e.g., one or more email recipients, one or more text message recipients, one or more social networking websites, one or more microblogging services, one or more video sharing websites, etc.) through the external destination share application component 332. In some embodiments only registered users are permitted to submit stories while in other embodiments any user of the system can submit stories.

In some embodiments, users may submit stories through one or more external destinations (e.g., through websites external to the online story sharing service). By way of a specific example, an external destination may use an API of the online story sharing service that is configured to allow a user to sign-in to the online story sharing service and submit a story.

In one embodiment, the submit story application component 314 is configured to allow users to submit stories in multiple different ways. For example, the submit story application component 314 allows users to type or upload a written portion of a story, upload a video or image portion of story, upload a link to a video or image portion of a story, and/or record (e.g., via a web cam or audio input) a video or audio recording of a story.

In one embodiment, the submit story application component 314 allows online friends of a user that submitted a story to supplement and/or edit the user's submitted story (in some circumstances after the user permits their story to be supplemented and/or edited). This allows multiple users to create stories together.

Each story that is submitted is tracked 370. For example, the following information related to the story may be tracked: the total number of views of the story, the aggregate rating of the story, the number of times the story has been shared, the number of times the story has been made a favorite, and/or the total amount of story contest earnings. As described previously, the user may use the statistics application component 322 to view the statistics related to their submitted stories. In one embodiment, an alert message is transmitted to a user if a story submitted by the user moves to be in the top stories of a contest or out of the top stories of the contest (e.g., the top 5 stories of the contest).

FIG. 17 illustrates an exemplary submit story application component 1710 according to one embodiment. The submit story application component 1710 allows a user to submit a story to the online story sharing service. The submit story application component 1710 includes a story title field 1715 where the user provides a title to the story, a category field 1720 where the user selects from one a predefined category (e.g., sports, news, travel, nightlife, food, celebrity, funny, etc.) or provides their own category for the story, a sub-category field 1725 that allows the user to select from a predefined sub-category of the category (e.g., for the sports category, subcategories may include football, baseball, basketball, hockey, soccer, racecar driving, golf, etc.) or provide their own sub-category for the story, a tags field 1730 that allows the user to provide own or more tags or keywords for the story (the tags or keywords may be used when users search for the story), and a story submission type field 1735 where the user selects a type of story and how the data is to be uploaded (e.g.,. text only, video story, image upload, video upload). Any written component of the story (e.g., an overview or brief description of the story) may be provided through the text editor 1740. After the story details have been provided, the user selects the post object 1750 to post the story to the online story sharing service.

In one embodiment, prior to allowing the story to be accessible by other users of the system, the content of the story is verified to determine whether it is an appropriate submission. For example, the textual content of the story may be scanned through a vulgarity filter and any vulgar words may either be automatically removed or edited or the story that includes vulgar words may be rejected. The category of the story may also be verified to ensure that submissions are categorized appropriately, which may be done to ensure that story contests are not manipulated by users to win rewards in lesser used categories.

In one embodiment, users can submit their stories as an entry in one or more story contests. In one embodiment each story submitted is automatically entered into one or more story contests, while in other embodiments users determine whether their stories are entered into a story contest. The winners of the contest are determined through a scoring system that is based on one or more of the following: the number of views a story has during the contest, the number of comments on the story during the contest, the number of ratings on the story during the contest, and the average rating of the story during the contest. Thus, the winner(s) of a story (e.g., first place, second place, etc.) are determined by involvement of the users of the system. The contests may be conducted daily, weekly, monthly, and/or other length of time. In some embodiments, category or sub-category specific contests are conducted. In one embodiment, the winner(s) of a particular contest are awarded a monetary reward (e.g., cash), virtual currency reward that may be exchanged for real-world goods or services (e.g., gift certificates), and/or other non-monetary award (e.g., a physical product, a service, an experience (e.g., a vacation, a concert, etc.), etc.).

A story submitted for a contest has a specific length of eligibility for each prize. For example, a story may be automatically entered into the following: a daily contest each day for one week, a weekly contest once a week for a month, and/or a monthly contest each month for two months (unless the story wins a prize which at that point the story is no longer eligible for that contest in some embodiments).

In one embodiment, in order to allow each story the same opportunity to improve its popularity rating by registering views (and to give it a chance to “go viral”), each story remains in competition for the same amount of time, which will be longer than the amount of time between prize awards. For example, for a daily contest, a story may have 72 hours to accumulate views, ratings, and/or comments. At the close of each daily contest, the winner will be chosen from only those stories which have completed their 72-hour competition period within the 24 hours since the close of the previous contest.

In one embodiment, a user is required to select a category and/or sub-category from a predefined list (e.g., from the drop down fields in the category field 1720 and/or the sub-category field 1725) when submitting a story to be entered into a contest for that category or sub-category. The category or sub-category contest is monitored to ensure that the submissions are categorized appropriately.

As described above, the contest scoring system is based on one or more of the following: the number of views a story has during the contest, the number of comments on the story during the contest, the number of ratings on the story during the contest, and the average rating of the story during the contest. The scoring system may be different for different contests (e.g., daily, weekly, and monthly contests).

In one embodiment, the online story sharing server 105 executes a contest scoring algorithm to assign a “popularity rating” from 0 to 100, where 0 represents a story with the least amount of interest in the current contest pool and 100 represents a story with the greatest amount of interest in the contest pool. The interest of a story is calculated based on each time a story is viewed, commented on, and/or rated (e.g., a point is added for each of these occurrences). In one embodiment, the IP address and/or user account name are the limiting factors for determining whether a comment, rating, and/or viewing of a story are included in the calculation of the popularity rating (e.g., in some embodiments, regardless of the actual number of times the story is viewed, commented, and/or rated by a particular viewer, only one view, comment, and/or rating (or other limited number of views, comments, and/or ratings) of that viewer is used when calculating the popularity rating). Thus, in some embodiments, an individual account holder can have at most three points for purposes of contest scoring: one for viewing the story, one for commenting on the story, and one for rating the story. Each additional time that the user views, comments, or rates the story will not be included for purposes of contest scoring. While the popularity rating has been described with respect to story views, comments, and ratings, it should be understood that these are exemplary and different and/or additional factors may be used during calculation (e.g., the number of times the story has been shared, the number of times the story has been made a favorite, etc.).

By way of a specific example, the formula for the popularity rating is indicated in formula 1, where V is the story view count, R is the story rating count, and C is the story comment count, the raw popularity (P) is equivalent to V+R+C, P(min) is the lowest raw popularity score of the stories in the contest, and P(max) is the highest raw popularity score of the stories in the contest:

Popularity Rating=(P−P(min)*100)/(P(max)−P(min)) (formula 1)

The contest scoring algorithm also assigns a “quality rating” from 0 to 100 where 0 represents the story with the lowest rating in the contest pool and 100 represents the highest rating in the contest pool according to one embodiment. By way of a specific example, the formula for the quality rating is indicated in formula 2, where S is the average rating of the story:

Quality Rating=(S−S(min)*100)/(S(max)−S(min)) (formula 2)

The overall rating of a story is then calculated as the average of the popularity and quality ratings as indicated by formula 3:

Overall Rating=(Popularity Rating+Quality Rating)/2 (formula 3)

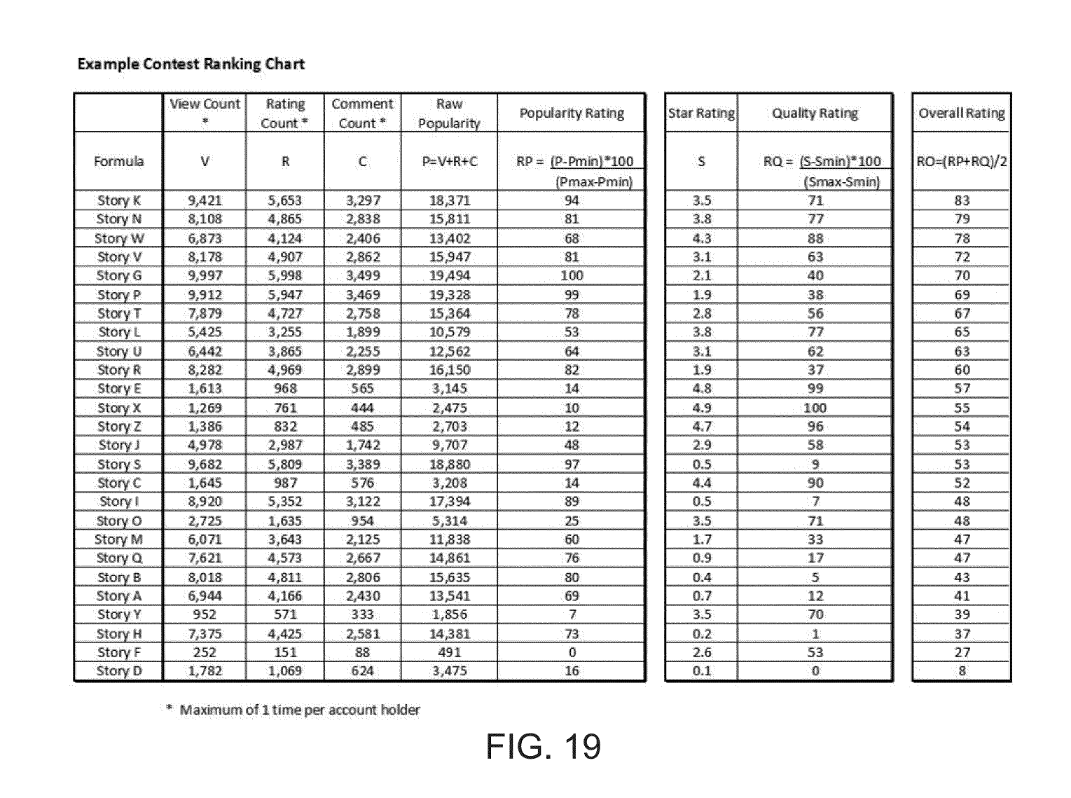

FIG. 19 illustrates an exemplary story ranking chart that illustrates calculation of the contest scoring algorithm for a story contest according to one embodiment. As illustrated in FIG. 19, Story K has the highest overall rating (a score of 83) and Story D has the lowest overall rating (a score of 8).

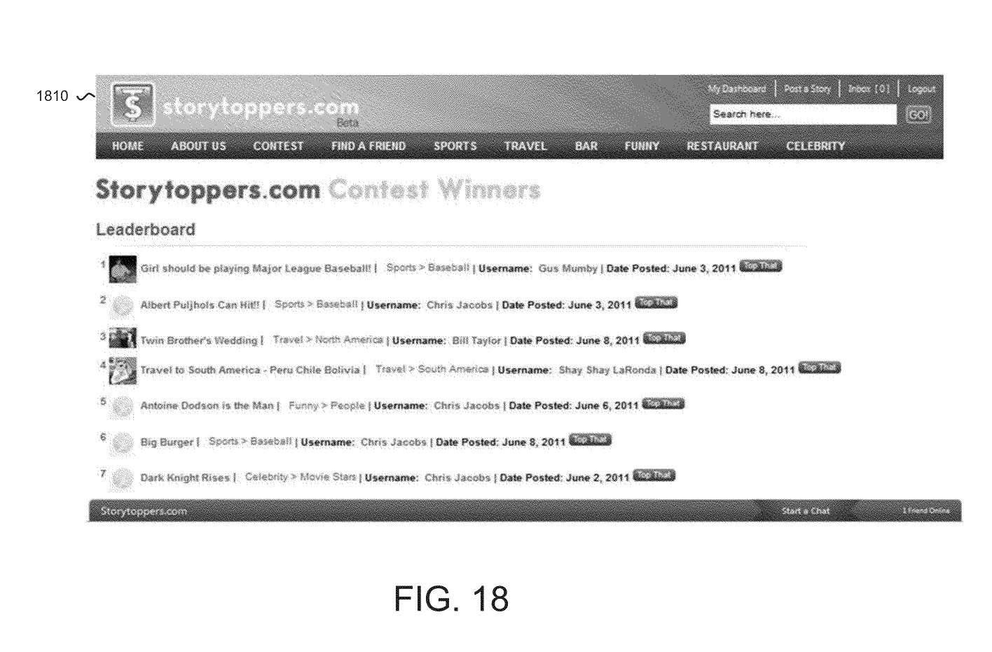

FIG. 18 illustrates an exemplary contest leaderboard application component 1810 according to one embodiment. By way of example, the leaderboard application component 1810 is displayed responsive to a user selecting the contest object 435, which is included on the home application component 410 as well as other application components. In one embodiment, the winner(s) of a particular contest are awarded a monetary reward (e.g., cash), virtual currency reward that may be exchanged for real-world goods or services (e.g., gift certificates), and/or other non-monetary award (e.g., a physical product, a service, an experience (e.g., a vacation, a concert, etc.), etc.). The number of winners may be different for different contests.

The leaderboard application component 1810 displays the current leaders of a story contest. A user can access nay of the stories by selecting that story. In addition, the leaderboard application component 1810 includes a “Top That” object associated with each story that allows users the opportunity to submit their own story in an attempt to top that story. Although not illustrated in FIG. 18, in some embodiments users select a particular category and contest to view a leaderboard of the currently winning stories. For example, if there are daily and weekly contests for one or more categories and/or subcategories, a user may select to view the leaderboard for a particular contest type of contest. By way of a specific example, the leaderboard application component 1810 is displaying results of a contest across multiple categories and/or sub-categories. For example, the story that is currently in first place is in the sports/baseball category/subcategory while the story that is currently in third place is in the travel/North America category/subcategory.

In some embodiments, the story contests are conducted by the online story sharing service and are available to all users (that is, all users may participate in the story contest by submitting story(ies), viewing stories, rating stories, commenting on stories, etc.). In other embodiments, the online story sharing service allows users to establish custom story contests. A custom story contest is defined and administered by one of the users through the online story sharing service. By way of example, a user may establish a custom story contest to be conducted between his/her online friends. As another example, contests may be conducted to determine which user can create the best contest (e.g., as determined by the number of participants and the total activity (e.g., views, comments, ratings, etc.) of the contests). As another example, an organization (e.g., a corporation, a charitable organization, or other organization) may establish a custom story contest to be conducted. For example, the user may configure the rules and contest parameters including the following: the duration of the contest; the subject matter of the story contest; how many contest entries are allowed for each user; what users are permitted to participate in the story contest; the contest scoring parameters; whether the stories that are submitted for the custom contest are viewable only to the users of the custom story contest or viewable to the general public; and the prize schedule for winner(s) of the story contest. In embodiments where the prize(s) for a custom story contest are monetary rewards, the online story sharing service includes the capability for the user to deposit the monetary rewards in an escrow account until the contest is complete.

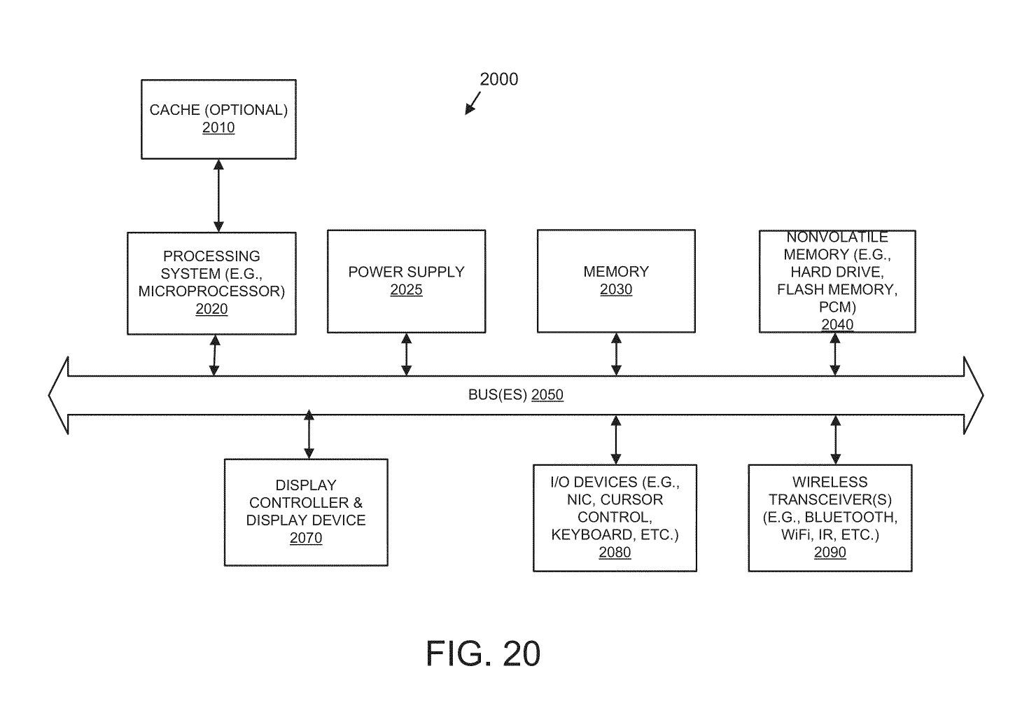

As illustrated in FIG. 20, the computer system 2000, which is a form of a data processing system, includes the bus(es) 2050 which is coupled with the processing system 2020, power supply 2025, memory 2030, and the nonvolatile memory 2040 (e.g., a hard drive, flash memory, Phase-Change Memory (PCM), etc.). The bus(es) 2050 may be connected to each other through various bridges, controllers, and/or adapters as is well known in the art. The processing system 2020 may retrieve instruction(s) from the memory 2030 and/or the nonvolatile memory 2040, and execute the instructions to perform operations described herein. For example, the processing system 2020 may retrieve instruction(s) form the memory 2030 and/or the nonvolatile memory and execute those instruction(s) to perform the functionality of the online story sharing server described herein.

The bus 2050 interconnects the above components together and also interconnects those components to the display controller & display device 2070, Input/Output devices 2080 (e.g., NIC (Network Interface Card), a cursor control (e.g., mouse, touchscreen, touchpad, etc.), a keyboard, etc.), and the wireless transceiver(s) 2090 (e.g., Bluetooth, WiFi, Infrared, etc.). In one embodiment, the online story sharing server 105 can take the form of the computer system 2000. Of course, it should be understood that the architecture of the computer system 2000 is exemplary and other, alternative architectures with more or less components may be used with embodiments described herein. For example, some architectures of computer systems used herein do not include a display controller and display device, I/O devices, and/or wireless transceivers.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., the online story sharing server 105). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory computer-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in an online story sharing server for conducting an online story contest, comprising:
receiving, across a network, a plurality of stories submitted by a plurality of users of an online story sharing service, wherein each of the plurality of stories includes one or more of a written component, an audio component, an image component, and a video component;
storing the plurality of stories in the online story sharing server such that each story may be presented to a user of the online story sharing service upon receipt across the network of a request from that user to view the story;
entering the plurality of stories in the online story contest, the online story contest being configured to operate for a predetermined duration of time;
tracking a set of one or more attributes for each of the plurality of stories during the duration of time, wherein the set of attributes for each story indicate an interest level of that story relative to an interest level of the other plurality of stories;
determining a set of one or more winning stories of the online story contest based on the set of tracked attributes associated with each of the plurality of stories; and
providing a reward to those of the plurality of users that submitted the set of winning stories.

2. The method of claim 1, wherein the set of tracked attributes for each story includes a total number of views of that story during the duration of time.

3. The method of claim 1, wherein the set of tracked attributes for each story further includes an average quality rating assigned to that story by users of the online story sharing service.

4. The method of claim 1, wherein the provided reward is one or more of:
a monetary reward,
a virtual currency reward, and
a non-monetary reward.

5. An apparatus of an online story sharing service, comprising:
a set of one or more processors;
a non-transitory computer readable storage medium that stores a computer program configured to execute on the set of processors, the computer program including:
a submit story application component configured to allow users of the online story sharing service to submit stories that include one or more of a written component, an audio component, an image component, and a video component;
a view story application component configured to allow users of the online story sharing service to view stories that have been submitted;
an external destination share application component configured to allow users of the online story sharing service to share links of stories with one or more external destinations; and
a story contest module configured to conduct story contests, wherein each story contest is for a predetermined duration of time and includes a plurality of stories as entries, wherein conducting a story contest includes performing the following:
track a set of one or more attributes for each of the plurality of stories entered into that story contest, wherein the set of attributes for each story includes one or more parameters that indicate an interest level of that story relative to an interest level of the other plurality of stories entered into that story contest,
determine a set of one or more winning stories of the story contest based on the set of tracked attributes associated with each of the plurality of stories entered into that story contest, and
provide a reward to those of the plurality of users that submitted the set of winning stories.

6. The apparatus of claim 5, wherein the computer program further includes:
a messaging application component configured to allow users of the online story sharing service to communicate with each other.

7. The apparatus of claim 5, wherein the one or more parameters that indicate the interest level for each story includes a total number of views of that story during the duration of time.

8. The apparatus of claim 5, wherein the set of tracked attributes for each story further includes an average quality rating assigned to that story by users of the online story sharing service.

9. The apparatus of claim 5, wherein the provided reward is one or more of:
a monetary reward,
a virtual currency reward, and
a non-monetary reward.

10. A non-transitory computer-readable storage medium that provides instructions that, if executed by a processor, will cause said processor to perform operations for conducting an online story contest comprising:
receiving, across a network, a plurality of stories submitted by a plurality of users of an online story sharing service, wherein each of the plurality of stories includes one or more of a written component, an audio component, an image component, and a video component;
storing the plurality of stories in the online story sharing server such that each story may be presented to a user of the online story sharing service upon receipt across the network of a request from that user to view the story;
entering the plurality of stories in the online story contest, the online story contest being configured to operate for a predetermined duration of time;
tracking a set of one or more attributes for each of the plurality of stories during the duration of time, wherein the set of attributes for each story indicate an interest level of that story relative to an interest level of the other plurality of stories;
determining a set of one or more winning stories of the online story contest based on the set of tracked attributes associated with each of the plurality of stories; and
providing a reward to those of the plurality of users that submitted the set of winning stories.
